(19) United States
(12) Patent Application Publication
(10) Pub. No.: US 2026/0037253 A1
(43) Pub. Date: Feb. 5, 2026

(54) OPTIMIZING DISRUPTIVE UPDATES FOR SINGLE NODE DEPLOYMENTS IN AN ORCHESTRATION PLATFORM

(71) Applicant: International Business Machines Corporation, Armonk, NY (US)

(72) Inventors: Amadeus Podvratnik, Wildberg (DE); Alexander Klein, Boeblingen (DE); Jan Schintag, Boeblingen (DE)

(21) Appl. No.: 18/790,258

(22) Filed: Jul. 31, 2024

(51) Int. Cl. G06F 8/656; G06F 9/455; G06F 9/48

(52) U.S. Cl. CPC G06F 8/656; G06F 9/45558; G06F 9/4856; G06F 2009/45562; G06F 2009/4557; G06F 2009/45575; G06F 2009/45595

(57) ABSTRACT

A computer-implemented method for updating a node in an orchestration platform. A processor set receives a patch of a disruptive update for the node in the orchestration platform. The node is a control plane node that is configured to run workloads. The processor set generates a copy for the node in the orchestration platform. The processor set allocates the workloads for the node to the copy for the node. The processor set updates the node using the patch of the disruptive update. The workloads are running on the copy for the node when the node is updating. The processor set allocates the workloads from the copy for the node back to the node upon finishing the disruptive update.

### BACKGROUND

The disclosure relates generally to orchestration platforms, and more specifically to updates for single node deployment in an orchestration platform.

An orchestration platform is designed to simplify the deployment management and scaling of containerized applications. An orchestration platform usually provides an integrated environment that offers web console and integrated development environments to streamline application development process. In this case, an orchestration platform can be used to automate various aspects of container managements such as automated scaling both horizontally and vertically to handle workloads efficiently. For example, an orchestration platform can adjust number of pod replicas based on resource usage for horizontal scaling and modifies the resources allocated to individual pods for vertical scaling.

A single node deployment refers to a configuration where all components of a system are deployed on a single physical or virtual machine. In this setup, the machine functions as both the control plane node and the worker node. For example, single node deployment on OpenShift® platform is also known as Single Node OpenShift® (SNO). In this case, SNO consolidates the entire OpenShift® cluster onto a single machine such that the single machine handles all control plane functions such as scheduling and worker nodes tasks such as running applications and services.

### SUMMARY

According to one illustrative embodiment, a computer-implemented method for updating a node in an orchestration platform is provided. A processor set receives a patch of a disruptive update for the node in the orchestration platform. The node is a control plane node that is configured to run workloads. The processor set generates a copy for the node in the orchestration platform. The processor set allocates the workloads for the node to the copy for the node. The processor set updates the node using the patch of the disruptive update. The workloads are running on the copy for the node when the node is updating. The processor set allocates the workloads from the copy for the node back to the node upon finishing the disruptive update. According to other illustrative embodiments, a computer system, and a computer program product for updating a node in an orchestration platform are provided.

### BRIEF DESCRIPTION OF THE DRAWINGS

FIG. 1 is a pictorial representation of a computing environment in which illustrative embodiments may be implemented;

FIG. 2 is an illustration of a block diagram of an update management environment in accordance with an illustrative embodiment;

FIG. 3 is an illustration of logical partitions and nodes in accordance with an illustrative embodiment;

FIG. 4 is a flowchart of a process for updating a node in an orchestration platform in accordance with an illustrative embodiment;

FIG. 5 is a flowchart of a process for updating a node in an orchestration platform in accordance with an illustrative embodiment;

FIG. 6 is a flowchart of a process for placing a copy for a node into a logical partition in accordance with an illustrative embodiment;

FIG. 7 is a flowchart of a process for identifying a second logical partition for placing the copy for the node in accordance with an illustrative embodiment;

FIG. 8 is a flowchart of a process for attaching a network interface to the copy for the node in accordance with an illustrative embodiment;

FIG. 9 is a flowchart of a process for routing the workloads from the node to the copy for the node in accordance with an illustrative embodiment;

FIG. 10 is a flowchart of a process for allocating the workloads from the copy for the node back to the node in accordance with an illustrative embodiment;

FIG. 11 is a block diagram of a data processing system in accordance with an illustrative embodiment.

### DETAILED DESCRIPTION

A computer implemented method updates a node in an orchestration platform. A processor set receives a patch of a disruptive update for the node in the orchestration platform. The node is a control plane node that is configured to run workloads. The processor set generates a copy for the node in the orchestration platform. The processor set allocates the workloads for the node to the copy for the node. The processor set updates the node using the patch of the disruptive update. The workloads are running on the copy for the node when the node is updating. The processor set allocates the workloads from the copy for the node back to the node upon finishing the disruptive update. As a result, the illustrative embodiments provide a technical effect of continuously running workloads while a disruptive update is performing on a node with single node deployment.

In the illustrative embodiments, the processor set determines whether a logical partition has sufficient computing resources to store the copy for the node. The node is located in the logical partition. The processor set stores the copy for the node into the logical partition in response to determining that the logical partition has sufficient computing resources to store the copy for the node. As a result, the illustrative embodiments provide a technical effect of having the node and the copy for the node in the same logical partitions to minimize overhead.

In the illustrative embodiments, the processor set identifies a second logical partition for placing the copy for the node. The second logical partition has lowest latency for the copy for the node to run the workloads. As a result, the illustrative embodiments provide a technical effect of placing the copy for the node into a logical partition that has lowest latency for the copy for the node to run the workloads when the copy for the node and the node cannot be stored into the same logical partition.

In the illustrative embodiments, the processor set reconfigures the logical partition to increase available computing resources in the logical partition in response to determining that the logical partition does not have sufficient computing resources to store the copy for the node. The processor set stores the copy for the node into the logical partition. As a result, the illustrative embodiments provide a technical effect of having the node and the copy for the node in the same logical partitions to minimize overhead.

In the illustrative embodiments, the processor set attaches a network interface to the copy for the node. The network interface comprises an internet protocol (IP) address and a medium access control (MAC) address that can be assigned to the copy for the node. As a result, the illustrative embodiments provide a technical effect of ensuring the copy for the node can effectively communicate with other components in the orchestration platform for running the workloads.

In the illustrative embodiments, the processor set adds the internet protocol (IP) address and a medium access control (MAC) address that can be assigned to the copy for the node to a network load balancer for the orchestration platform. The processor set assigns the internet protocol (IP) address and the medium access control (MAC) address to the copy for the node. The processor set routes the workloads from the node to the copy for the node using the network load balancer. As a result, the illustrative embodiments provide a technical effect of rerouting the workloads from the node to the copy for the node such that the workloads can be continuously running during disruptive update for the node.

In the illustrative embodiments, as part of allocating the workloads from the copy for the node back to the node upon finishing the disruptive update, the processor set connects the node and the copy for the node to form a two node cluster. The processor set sets the copy for the node to be unavailable for running new workloads. The processor terminates the workloads running on the copy for the node in a sequential manner. The workloads are restarted on the node according to sequence for the sequential manner after the workloads are terminated on the copy for the node. The processor set deletes the copy for the node after all workloads running on the copy for the node are terminated. As a result, the illustrative embodiments provide a technical effect of effectively allocating and managing computing resources by deleting the copy for the node after the disruptive update performed on the node is completed.

A computer system comprises a processor set, a set of one or more computer-readable storage media, and program instructions, collectively stored in the set of one or more storage media, for causing the processor set to perform the following computer operations. The processor set receives a patch of a disruptive update for the node in the orchestration platform. The node is a control plane node that is configured to run workloads. The processor set generates a copy for the node in the orchestration platform. The processor set allocates the workloads for the node to the copy for the node. The processor set updates the node using the patch of the disruptive update. The workloads are running on the copy for the node when the node is updating. The processor set allocates the workloads from the copy for the node back to the node upon finishing the disruptive update. As a result, the illustrative embodiments provide a technical effect of continuously running workloads while a disruptive update is performing on a node with single node deployment.

In the illustrative embodiments, the processor set further executes the program instructions to determine whether a logical partition has sufficient computing resources to store the copy for the node. The node is located in the logical partition. The processor set further executes the program instructions to store the copy for the node into the logical partition in response to determining that the logical partition has sufficient computing resources to store the copy for the node. As a result, the illustrative embodiments provide a technical effect of having the node and the copy for the node in the same logical partitions to minimize overhead.

In the illustrative embodiments, the processor set further executes the program instructions to identify a second logical partition for placing the copy for the node. The second logical partition has lowest latency for the copy for the node to run the workloads. As a result, the illustrative embodiments provide a technical effect of placing the copy for the node into a logical partition that has lowest latency for the copy for the node to run the workloads when the copy for the node and the node cannot be stored into the same logical partition.

In the illustrative embodiments, the processor set further executes the program instructions to reconfigure the logical partition to increase available computing resources in the logical partition in response to determining that the logical partition does not have sufficient computing resources to store the copy for the node. The processor set further executes the program instructions to store the copy for the node into the logical partition. As a result, the illustrative embodiments provide a technical effect of having the node and the copy for the node in the same logical partitions to minimize overhead.

In the illustrative embodiments, the processor set further executes the program instructions to attach a network interface to the copy for the node. The network interface comprises an internet protocol (IP) address and a medium access control (MAC) address that can be assigned to the copy for the node. As a result, the illustrative embodiments provide a technical effect of ensuring the copy for the node can effectively communicate with other components in the orchestration platform for running the workloads.

In the illustrative embodiments, the processor set further executes the program instructions to add the internet protocol (IP) address and a medium access control (MAC) address that can be assigned to the copy for the node to a network load balancer for the orchestration platform. The processor set further executes the program instructions to assign the internet protocol (IP) address and the medium access control (MAC) address to the copy for the node. The processor set further executes the program instructions to route the workloads from the node to the copy for the node using the network load balancer. As a result, the illustrative embodiments provide a technical effect of rerouting the workloads from the node to the copy for the node such that the workloads can be continuously running during disruptive update for the node.

In the illustrative embodiments, as part of allocating the workloads from the copy for the node back to the node upon finishing the disruptive update, the processor set further executes the program instructions to connects the node and the copy for the node to form a two node cluster. The processor set further executes the program instructions to set the copy for the node to be unavailable for running new workloads. The processor set further executes the program instructions to terminate the workloads running on the copy for the node in a sequential manner. The workloads are restarted on the node according to sequence for the sequential manner after the workloads are terminated on the copy for the node. The processor set further executes the program instructions to delete the copy for the node after all workloads running on the copy for the node are terminated. As a result, the illustrative embodiments provide a technical effect of effectively allocating and managing computing resources by deleting the copy for the node after the disruptive update performed on the node is completed.

In the illustrative embodiments, a computer program product manages data transformation tools. The computer program product comprises a set of one or more computer-readable storage media and program instructions, collectively stored in the set of one or more storage media, for causing a processor set to perform the following computer operations. The program instructions are executable by a computer system to receive a patch of a disruptive update for the node in the orchestration platform. The node is a control plane node that is configured to run workloads. The program instructions are executable by a computer system to cause the computer system to generate a copy for the node in the orchestration platform. The program instructions are executable by a computer system to cause the computer system to allocate the workloads for the node to the copy for the node. The program instructions are executable by a computer system to cause the computer system to update the node using the patch of the disruptive update. The workloads are running on the copy for the node when the node is updating. The program instructions are executable by a computer system to cause the computer system to allocate the workloads from the copy for the node back to the node upon finishing the disruptive update. As a result, the illustrative embodiments provide a technical effect of continuously running workloads while a disruptive update is performing on a node with single node deployment.

In the illustrative embodiments, the program instructions are further executable by the computer system to cause the computer system to determine whether a logical partition has sufficient computing resources to store the copy for the node. The node is located in the logical partition. The program instructions are further executable by the computer system to cause the computer system to store the copy for the node into the logical partition in response to determining that the logical partition has sufficient computing resources to store the copy for the node. As a result, the illustrative embodiments provide a technical effect of having the node and the copy for the node in the same logical partitions to minimize overhead.

In the illustrative embodiments, the program instructions are further executable by the computer system to cause the computer system to identify a second logical partition for placing the copy for the node. The second logical partition has lowest latency for the copy for the node to run the workloads. As a result, the illustrative embodiments provide a technical effect of placing the copy for the node into a logical partition that has lowest latency for the copy for the node to run the workloads when the copy for the node and the node cannot be stored into the same logical partition.

In the illustrative embodiments, the program instructions are further executable by the computer system to cause the computer system to reconfigure the logical partition to increase available computing resources in the logical partition in response to determining that the logical partition does not have sufficient computing resources to store the copy for the node. The program instructions are further executable by the computer system to cause the computer system to store the copy for the node into the logical partition. As a result, the illustrative embodiments provide a technical effect of having the node and the copy for the node in the same logical partitions to minimize overhead.

In the illustrative embodiments, the program instructions are further executable by the computer system to cause the computer system to attach a network interface to the copy for the node. The network interface comprises an internet protocol (IP) address and a medium access control (MAC) address that can be assigned to the copy for the node. As a result, the illustrative embodiments provide a technical effect of ensuring the copy for the node can effectively communicate with other components in the orchestration platform for running the workloads.

In the illustrative embodiments, as part of allocating the workloads from the copy for the node back to the node upon finishing the disruptive update, the program instructions are further executable by the computer system to cause the computer system to connect the node and the copy for the node to form a two node cluster. The program instructions are further executable by the computer system to cause the computer system to set the copy for the node to be unavailable for running new workloads. The program instructions are further executable by the computer system to cause the computer system to terminate the workloads running on the copy for the node in a sequential manner. The workloads are restarted on the node according to sequence for the sequential manner after the workloads are terminated on the copy for the node. The program instructions are further executable by the computer system to cause the computer system to delete the copy for the node after all workloads running on the copy for the node are terminated. As a result, the illustrative embodiments provide a technical effect of effectively allocating and managing computing resources by deleting the copy for the node after the disruptive update performed on the node is completed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

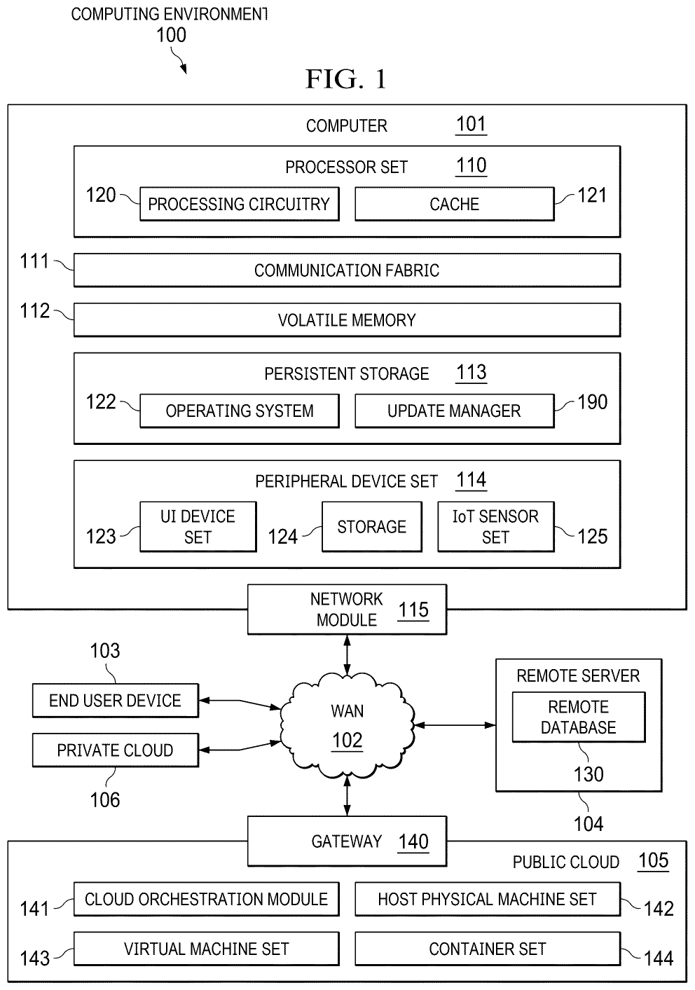

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as update manager 190. In addition to update manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and update manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in update manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in update manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that single node deployment for scheduling workloads in an orchestration platform can be used to optimize existing workloads on the orchestration platform to save computing resources. The illustrative embodiments recognize and take into account that single node deployment for an orchestration platform only has one control plane node and at least three nodes are required to enable rolling updates. In this illustrative example, rolling restart of control plane nodes are not possible for single node deployment for the orchestration platform.

The illustrative embodiments also recognize and take into account that multi-node setup in an orchestration platform is able to install disruptive updates but the overall costs for setting up and maintaining multi-node setup is much higher compared to single node deployment in the orchestration platform.

In addition, the illustrative embodiments also recognize and take into account that simply adding worker nodes to a single node deployment in an orchestration platform will still leave the cluster headless for planned outages and causes disruptions for certain workloads. The illustrative embodiments also recognize and take into account that planned outages for disruptive hardware changes or updates will impact cluster availability for nodes in an orchestration platform.

Thus, illustrative embodiments of the present invention provide a computer implemented method, computer system, and computer program product for updating nodes in an orchestration platform in an autonomous manner to increase computer performance. A processor set receives a patch of a disruptive update for the node in the orchestration platform. The node is a control plane node that is configured to run workloads. The processor set generates a copy for the node in the orchestration platform. The processor set allocates the workloads for the node to the copy for the node. The processor set updates the node using the patch of the disruptive update. The workloads are running on the copy for the node when the node is updating. The processor set allocates the workloads from the copy for the node back to the node upon finishing the disruptive update.

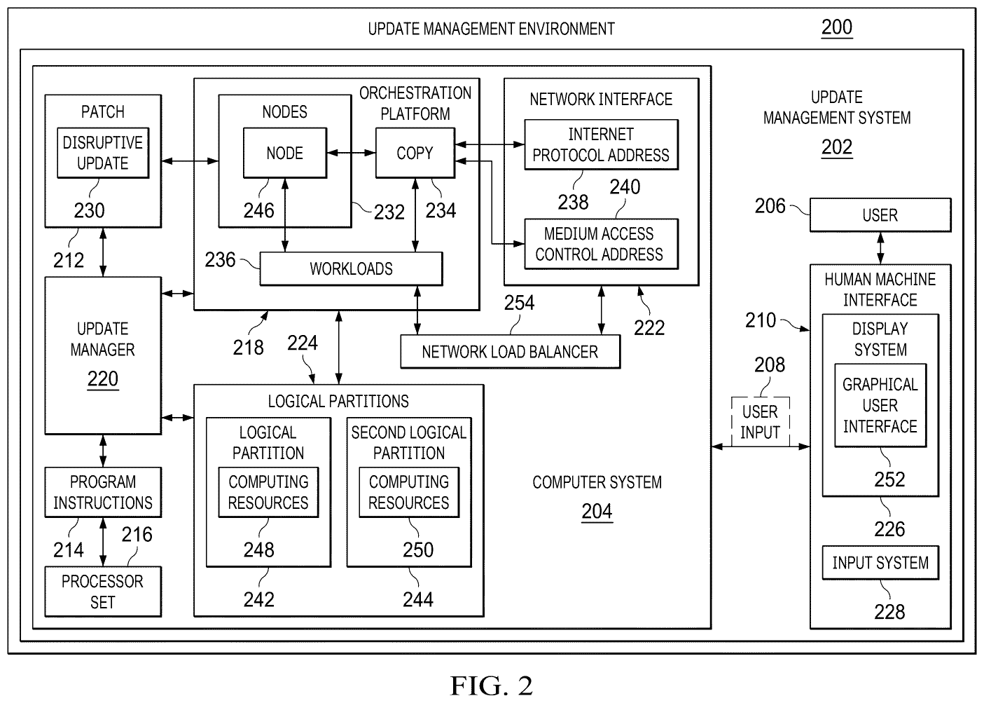

With reference now to FIG. 2, an illustration of a block diagram of an update management environment is depicted in accordance with an illustrative embodiment. In this illustrative example, update management environment 200 includes components that can be implemented in hardware such as the hardware shown in computing environment 100 in FIG. 1.

In this illustrative example, update management system 202 in update management environment 200 performs update for nodes 232 of orchestration platform 218 in computer system 204. In this illustrative example, update management system 202 includes computer system 204 which includes update manager 220. Update manager 220 is located in computer system 204. Update manager 220 may be implemented using update manager 190 in FIG. 1.

Update manager 220 can be implemented in software, hardware, firmware, or a combination thereof. When software is used, the operations performed by update manager 220 can be implemented in program instructions configured to run on hardware, such as a processor unit. When firmware is used, the operations performed by update manager 220 can be implemented in program instructions and data and stored in persistent memory to run on a processor unit. When hardware is employed, the hardware can include circuits that operate to perform the operations in update manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

As used herein, “medium access control (MAC) address” refers to a unique identifier assigned to a network interface controller of a device for communication within a network. In this illustrative example, “medium access control (MAC) address” can also be referred to as “media access control (MAC) address”.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, computer system 204 includes orchestration platform 218. Orchestration platform 218 is a system designed to manage and automate the configuration, deployment, and operation of components in a software environment. For example, orchestration platform 218 can be Kubernetes® platform, which is an open-source system for automating the deployment, scaling, and management of containerized applications.

In this illustrative example, orchestration platform 218 includes a number of nodes 232. Nodes 232 are physical or virtual machines that are responsible for managing and executing containerized applications to run workloads 236. In this illustrative example, nodes 232 can be configured to function as both control plane node and worker node. In this illustrative example, the control plane node serves as the control plane that manages cluster operations such as scheduling, resource allocation, and maintaining state of containerized applications. On the other hand, the worker node handles workloads and executes application containers on orchestration environment. In addition, nodes 232 can also be configured to handle infrastructure tasks such as networking and storage. In other words, each node from nodes 232 is configured to perform all functions from different components such as worker node and control plane node of a cluster. In this illustrative example, such architecture for nodes 232 can also be referred to as single node deployment or single node clusters.

In this illustrative example, workloads 236 are applications and services that run on nodes 232. Workloads 236 can be packaged as containerized applications and are managed through abstractions for orchestration platform 218. For example, workloads 236 can be packaged as pods if orchestration platform 218 is a Kubernetes® platform. In this example, a pod is a group of one or more containers that share storage, network, and configurations for how to run the containers. In this illustrative example, containers are lightweight, portable, and self-sufficient units that package an application along with dependencies, libraries, and configuration files for the application.

In this illustrative example, nodes 232 uses computing resources from logical partitions 224 for running and managing workloads 236. In this illustrative example, logical partitions are segments of computing resources that can be used for running and managing workloads 236. Logical partitions 224 can help nodes 232 to optimize resource usage, enhance security, and ensure that workloads from workloads 236 can run smoothly without interfering with each other. In some illustrative examples, nodes 232 can be stored in logical partitions 224.

For example, node 246 can utilize computing resources 248 from logical partition 242 to run and manage workloads 236. In this illustrative example, computing resources 248 can include central processing unit (CPU), memory, storage, networking resources, hardware accelerators such as crypto express cards, or any computing resources that are used to run and manage workloads 236.

In this illustrative example, update manager 220 can perform updates for nodes in nodes 232. For example, update manager 220 can perform updates for node 246 when orchestration platform 218 receives patch 212 for updating node 246. In this illustrative example, patch 212 includes disruptive update 230 that will interrupt the normal operation and causes downtime for node 246. For example, patch 212 can be a patch released for a database management system that includes disruptive update 230 for fixing a severe security flaw allowing unauthorized access to sensitive data. This illustrative example, disruptive update 230 in patch 212 can include overhauling the system's authentication mechanism, altering the way user sessions are managed, and updating encryption protocols. Those changes can result in the database to be temporarily taken offline, disrupting ongoing operations and potentially necessitating downtime for applications that are relying on the database.

As depicted, disruptive update 230 can cause complete downtime and critical service interruption for node 246, especially when node 246 is configured as single node cluster. In this illustrative example, update manager 220 can create copy 234 for node 246 such that workloads 236 can be handled by copy 234 while update manager 220 is performing update for node 246 based on disruptive update 230.

In this illustrative example, copy 234 can be created by cloning node 246. For example, update manager 220 can clone node 246 by first copying the root disk from node 246, which can include operating system, applications, and initial configurations. After the copy of root disk for node 246 is generated, update manager 220 mounts the copy of root disk for node 246 to allow access to the filesystem contained within the disk image. Subsequently, update manager 220 changes configuration on the copy of root disk for node 246 such that settings such as network configurations, hostnames, or node identifiers are set up correctly to ensure copy 234 operates smoothly.

In some illustrative embodiments, update manager 220 can also update the zIPL (z/OS Initial Program Loader). In this illustrative example, zIPL is a bootloader that plays a crucial role to ensure copy 234 boots correctly with the modified configurations. As a result, copy 234 is created as a copy for node 246.

In this illustrative example, it is preferable to identify logical partition from logical partitions 224 for copy 234 before copy 234 is created. In this illustrative example, it is preferable to utilize the same logical partition for both node 246 and copy 234 to minimize overheads. However, it is possible that computing resources 248 is not sufficient to be utilized by both node 246 and copy 234.

In this illustrative example, update manager 220 can identify second logical partition 244, which has sufficient computing resources in computing resources 250 for copy 234 and lowest latency for running and managing workloads 236. In a similar fashion, computing resources 250 can include central processing unit (CPU), memory, storage, networking resources, hardware accelerators such as crypto express cards, or any computing resources that are required to run and manage workloads 236.

In this illustrative example, sufficient computing resources refer to the amount of computing resources for a node in nodes 232 to efficiently handle assigned workloads. For example, computing resources 248 can be sufficient for node 246 if computing resources 248 provides adequate CPU, memory, storage, and network bandwidth for node 246 to efficiently run workloads 236.

In this illustrative example, update manager 220 can further attach network interface 222 to copy 234 such that copy 234 can communicate with other components of orchestration platform 218 and computer system 204. In this illustrative example, network interface 222 can include the internet protocol (IP) address 238 and medium access control (MAC) address 240. In this illustrative example, internet protocol address 238 and medium access control address 240 are assigned to copy 234 and are added to network load balancer 254. In this illustrative example, network load balancer is device or software that distributes incoming network traffic across computer system 204 and orchestration platform 218. In other words, network load balancer 254 manages network traffic for nodes 232 for running workloads 236. In this illustrative example, update manager 220 can use network load balancer 254 to route workloads 236 to copy 234 such that workloads 236 runs without interruption, even when node 246 is updating based on disruptive update 230.

In this illustrative example, update manager 220 can also create and maintain a table that includes information associated with status and updates associated with nodes in nodes 232. For example, the table created by update manager 220 can include necessary updates and disruptive updates for nodes in nodes 232 that utilize particular logical partition in logical partitions 224. In another example, the table created by update manager 220 can include nodes in nodes 232 that should not have interruptions or downtime. In this illustrative example, update manager 220 can use the table to manage and schedule updates more efficiently for nodes 232 in orchestration platform 218.

In this illustrative example, user 206 can interact with computer system 204 through user inputs to computer system 204. For example, computer system 204 can receive user input 208 that includes commands to stop or initiate updates for nodes 232.

In this illustrative example, user input 208 can be generated by user 206 using human machine interface (HMI) 210. As depicted, human machine interface 210 includes display system 226 and input system 228. Display system 226 is a physical hardware system and includes one or more display devices on which graphical user interface 252 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 252 through user input 208 generated by input system 228. Input system 228 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device. For example, user 206 can view update status for nodes 232, patch information for patch 212, and error encountered by update manager 220 when updating nodes in nodes 232.

In one illustrative example, one or more solutions are present that overcome a problem with updating nodes that are configured as single node clusters in an orchestration platform. As a result, one or more technical solutions may provide an ability to increase the efficiency and performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which update manager 220 in computer system 204 enables disruptive updates for nodes 232, especially when nodes 232 are configured as single node clusters. In particular, update manager 220 transforms computer system 204 into a special purpose computer system as compared to currently available general computer systems that do not have update manager 220.

In the illustrative example, the use of update manager 220 in computer system 204 integrates processes into a practical application for updating single node clusters without interrupting normal operations for single node clusters. In other words, update manager 220 in computer system 204 is directed to a practical application of processes integrated into update manager 220 in computer system 204 that updates single node clusters in an orchestration platform without interrupting workloads running on the single node clusters. In this illustrative example, update manager 220 can efficiently help computer system 204 to increase computer performance and avoid wasting computing resources because workloads 236 can run smoothly on orchestration platform 218 without interruptions even when the node that running workloads 236 is performing disruptive updating.

The illustration of update management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, second logical partition 244 can be identified as multiple logical partitions across logical partition 224 such that each logical partition provides a portion of computing resources required for copy 234 to manage and run workloads 236.

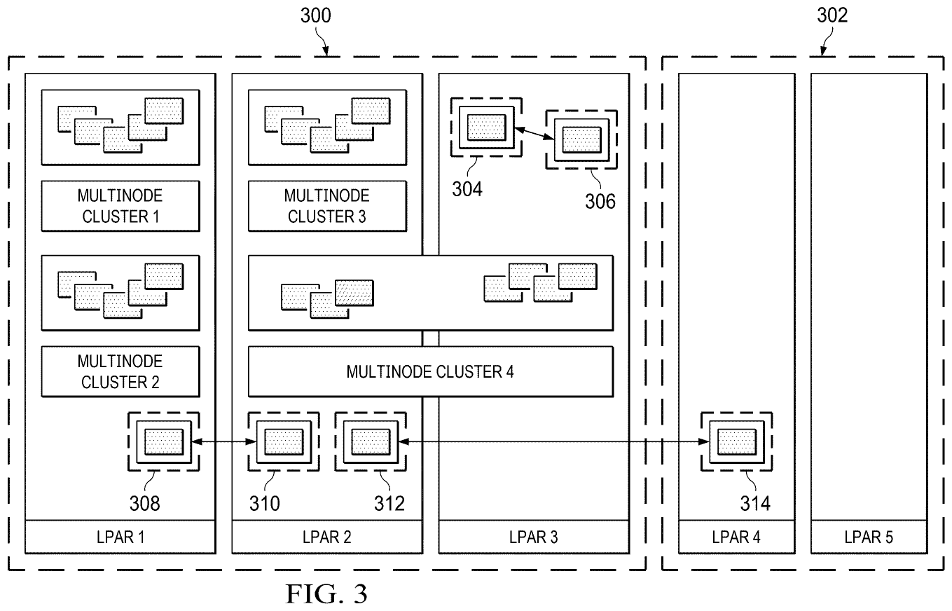

With reference now to FIG. 3, an illustration of logical partitions and nodes is shown in accordance with an illustrative embodiment. In this illustrative example, node 304, node 308, and node 312 can be examples of node 246 in FIG. 2. In addition, node 306, node 310, and node 314 can be examples of copy 234 in FIG. 2.

In FIG. 3, each node from node 304, node 306, node 308, node 310, node 312, and node 314 refers to a physical or virtual machine that serves as control plane node and worker node at the same time. As depicted, control plane node serves as the control plane that manages cluster operations such as scheduling, resource allocation, and maintaining state of applications. On the other hand, the worker node handles workloads and executes application containers on orchestration environment. In addition, the nodes can also be configured to handle infrastructure tasks such as networking and storage. In other words, each node from node 304, node 306, node 308, node 310, node 312, and node 314 is configured to perform all functions from different components such as worker node and control plane node of a cluster. As depicted, such architecture for a node can also be referred to as a single node cluster.

In this illustrative example, logical partitions are residing in different data centers that are configured to run workloads. For example, logical partition 1 (LPAR 1), logical partition 2 (LPAR 2), and logical partition 3 (LPAR 3) reside in data center 300, and logical partition 4 (LPAR 4) and logical partition 5 (LPAR 5) reside in data center 302. In this illustrative example, logical partitions in data center 300 and data center 302 are used to divide computer resources for data center 300 and data center 302 such that workloads are running efficiently in data center 300 and data center 302.

In FIG. 3, logical partitions in data center 300 and data center 302 are already configured to store files and applications for running workloads. In this illustrative example, multimode cluster 1 and multimode cluster 2 are stored in logical partition 1 and use computing resources from logical partition 1 for running workloads. In a similar fashion, multimode cluster 3 is stored in logical partition 2 and uses computing resources from logical partition 1 for running workloads. In this illustrative example, multimode cluster 4 is stored across logical partition 2 and logical partition 3. Multimode cluster 4 uses computing resources from both logical partition 2 and logical partition 3 for running workloads.

In this illustrative example, node 304, node 308, and node 312 reside in logical partition 3, logical partition 1, and logical partition 2, respectively. As depicted, disruptive update for a node that is single node cluster will cause interruption and downtime for the node. Therefore, a copy for the node can be created to efficiently handle the workloads run by the node while the node is updating. In this illustrative example, it is preferrable to store the copy for the node into the same logical partition that contains the node such that the latency for allocating workloads and running workloads is at minimal. For example, node 304 and node 306, which is a copy for node 304, can be both stored in logical partition 3 because logical partition 3 has sufficient computing resources for placing node 306.

However, it is possible that sometimes the node and the copy for the node cannot be stored into the same logical partition. For example, node 308 and node 310, which is a copy for node 308, cannot be stored into the same logical partition because logical partition 1 does not have sufficient computing resources for placing node 310. In this illustrative example, node 310 can be stored in a logical partition that has the lowest latency for allocating workloads and running workloads for node 308. In this illustrative example, node 310 can be stored in logical partition 2 such that the latency for allocating workloads and running workloads for node 308 is minimal because logical partition 1 and logical partition 2 are both located in data center 300.

In addition, a copy for a node can be stored into logical partition of another data center in the case that none of the logical partition in the same data center has sufficient computing resources to store the copy for the node. For example, node 314, which is a copy for node 312, cannot be stored in any logical partition in data center 300 because none of the logical partition has sufficient computing resources to store node 314. In this example, node 314 can be stored in logical partition 4 of data center 302 for running workloads for node 312 while node 312 is updating.

The illustration of placing copies of nodes in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, a copy for a node can be stored into multiple logical partitions in a distributed manner such that each logical partition contains a portion for the copy for the node.

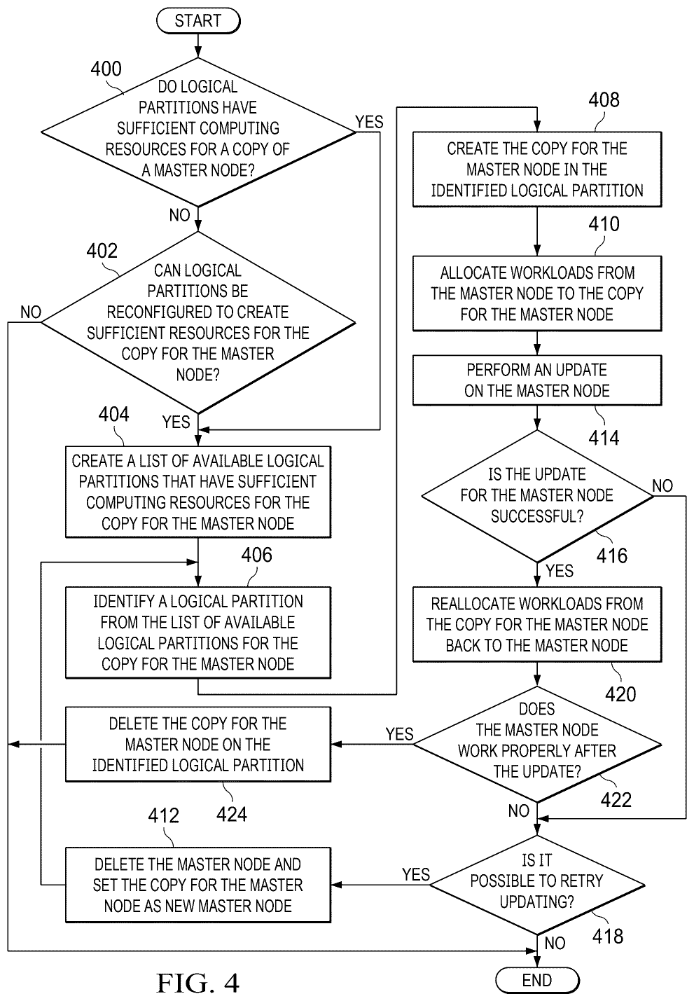

With reference now to FIG. 4, a flowchart illustrating a process for updating a node in an orchestration platform is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in update manager 220 in computer system 204 in FIG. 2.

The process begins by determining whether logical partitions have sufficient computing resources for a copy of a master node (step 400). In step 400, the master node can be an example of node 246 in FIG. 2, and node 304, node 308, and node 312 in FIG. 3. In other words, the master node is a single node cluster that functions as a control plane and is also configured to run workloads. In other words, the master node in FIG. 4 is a control plane node that is configured to run workloads. In this illustrative example, the computing resources can include network resources, storage resources, hardware resources, or any resources that can be used by the copy of the master node to run workloads. In other words, the process determines whether the logical partitions have sufficient computing resources for placing and running the copy of master node.

If the logical partitions do not have sufficient resources for placing the copy for the master node, the process determines whether the logical partitions can be reconfigured to create sufficient resources for the copy for the master node (step 402). If the logical partitions cannot be reconfigured to create sufficient resources for the copy for the master node, the process terminates thereafter.

With reference again to step 402, if the logical partitions can be reconfigured to create sufficient resources for the copy for the master node, the process proceeds to step 404.

With reference again to step 400, if logical partitions have sufficient computing resources for a copy of a master node, the process also proceeds to step 404. The process creates a list of available logical partitions that have sufficient computing resources for the copy for the master node (step 404). The process identifies a logical partition from the list of available logical partitions for the copy for the master node (step 406). In an alternative embodiment, multiple logical partitions can be identified for the copy for the master node. For example, network resources, storage resources, and hardware resources can be provided by different logical partitions such that the copy for the master node can run workloads for the master node while master node is updating.

The process creates the copy for the master node in the identified logical partition (step 408). In this illustrative example, computing resources such as network protocols and disk space are also configured for the copy for the master node. In this illustrative example, a health check can be performed to the copy for the master node to ensure that the copy for the master node is functioning correctly. In an alternative embodiment, the copy for the master node can be stored across multiple logical partitions if multiple logical partitions are identified for the copy for the master node.

The process allocates workloads from the master node to the copy for the master node (step 410). In step 410, the workloads are allocated from the master node to the copy for the master node for processing such that the workloads keep running while the master node is being updated. In other words, pods that contain the containers for running the workloads are evicted on the master node and restarted to continue to run the workloads on the copy for the master node.

The process performs an update on the master node (step 414). In this illustrative example, the update performed on the master node can be a disruptive update. The process determines whether the update for the master node is successful (step 416). In this illustrative example, the update for the master node can be unsuccessful due to a number of reasons. For example, error can be encountered during update or the pods that contain containers for running the workloads cannot be evicted on the master node.

If the update for the master node is not successful, the process proceeds to step 418 to determine whether it is possible to retry updating (step 416). If another update cannot be performed, the process terminates thereafter.

With reference again to step 418, if it is possible to retry updating, the process deletes the master node and sets the copy for the master node as new master node (step 412). As a result, the copy for the master node replaces the master node as new master node for further processing. In other words, the process can now repeat the process on the copy for the master node and perform the update on the copy for the master node such that the issues associated with the original master node will not be encountered again. The process proceeds to step 406 and repeats step 406 to step 418 until the update for the master node is successful.

With reference again to step 416, if the update for the master node is successful, the process reallocates workloads from the copy for the master node back to the master node (step 420). The process determines whether the master node works properly after the update (step 422). After the update, the master node may not be functioning properly because of issues such as connectivity errors or other errors. If the master node does not work properly after update, the process proceeds to step 418 to determine whether another update for node can be performed. If it is possible to retry updating, the process proceeds to step 412 and subsequently to step 406 and then repeats step 406 to step 422 until the master node works properly after the update.

With reference again to step 422, if the master node works properly after the update, the process deletes the copy for the master node on the identified logical partition (step 424). The process terminates thereafter.

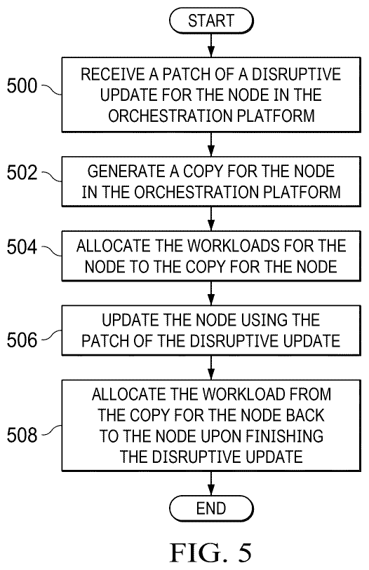

With reference now to FIG. 5, a flowchart illustrating a process for updating a node in an orchestration platform is shown in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in update manager 220 in computer system 204 in FIG. 2.

The process begins by receiving a patch of a disruptive update for the node in the orchestration platform (step 500). In step 500, the node is a control plane node that is configured to run workloads. The process generates a copy for the node in the orchestration platform (step 502). The process allocates the workloads for the node to the copy for the node (step 504). The process updates the node using the patch of the disruptive update (step 506). In step 506, the workloads are running on the copy for the node when the node is updating. The process allocates the workload from the copy for the node back to the node upon finishing the disruptive update (step 508). The process terminates thereafter.

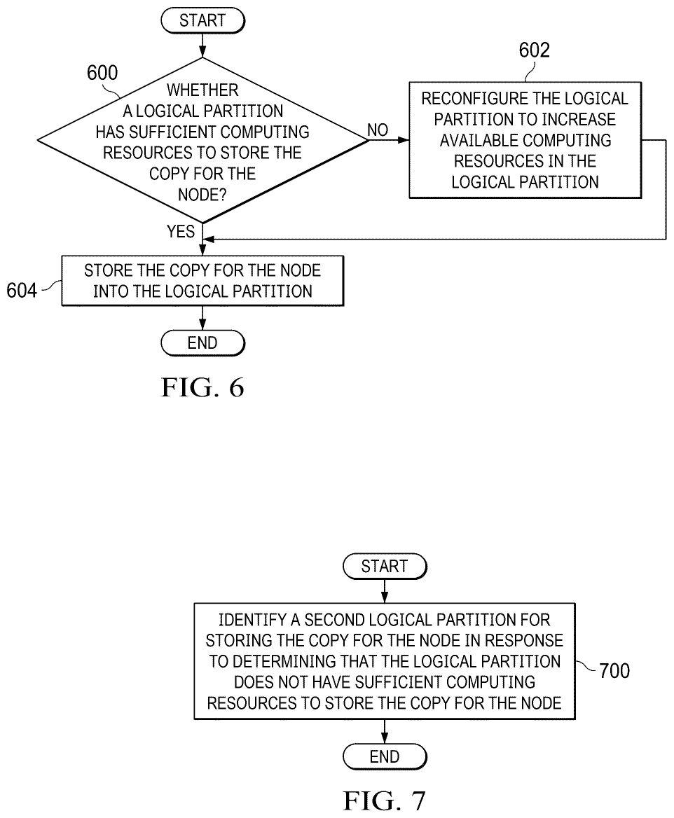

With reference now to FIG. 6, a flowchart illustrating a process for placing a copy for a node into a logical partition is shown in accordance with an illustrative embodiment. The process in this figure is an example of an additional step that can be performed with the steps in FIG. 5.

The process begins by determining whether a logical partition has sufficient computing resources to store the copy for the node (step 600). In step 600, the node is located in the logical partition. In this illustrative example, the process proceeds to step 604 in response to determining that the logical partition has sufficient computing resources to store the copy for the node.

With reference again to step 600, if the logical partition does not have sufficient computing resources to store the copy for the node, the process reconfigures the logical partition to increase available computing resources in the logical partition (step 602). In this illustrative example, the process also proceeds to step 604 after reconfiguring the logical partition. The process stores the copy for the node into the logical partition in response to determining that the logical partition has sufficient computing resources to store the copy for the node (step 604). The process terminates thereafter.

With reference now to FIG. 7, a flowchart illustrating a process for identifying a second logical partition for placing the copy for the node is shown in accordance with an illustrative embodiment. The process in this figure is an example of an additional step that can be performed with the steps in FIG. 6.

The process begins by identifying a second logical partition for placing the copy for the node in response to determining that the logical partition does not have sufficient resources to store the copy for the node (step 700). In step 700, the second logical partition has lowest latency for the copy for the node to run the workloads. The process terminates thereafter. In this illustrative example, the process identifies the second logical partition for placing the copy for the node when the logical partition that contains the node cannot be reconfigured. In other words, the process attempts to store the node and the copy for the node into same logical partition before identifying the second logical partitions for placing the copy for the node.

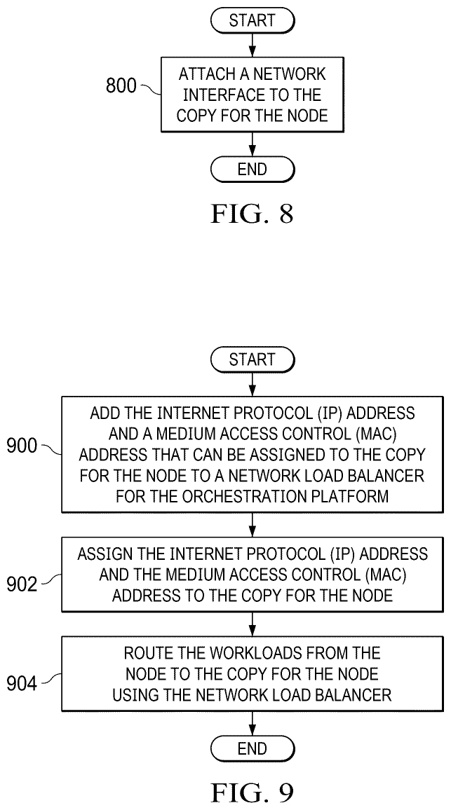

With reference now to FIG. 8, a flowchart illustrating a process for attaching a network interface to the copy for the node is shown in accordance with an illustrative embodiment. The process in this figure is an example of an additional step that can be performed with the steps in FIG. 5.

The process begins by attaching a network interface to the copy for the node (step 800). In step 800, the network interface comprises an internet protocol (IP) address and a medium access control (MAC) address that can be assigned to the copy for the node. The process terminates thereafter.

With reference now to FIG. 9, a flowchart illustrating a process for routing the workloads from the node to the copy for the node is shown in accordance with an illustrative embodiment. The process in this figure is an example of an additional step that can be performed with the steps in FIG. 8.

The process begins by adding the internet protocol (IP) address and a medium access control (MAC) address that can be assigned to the copy for the node to a network load balancer for the orchestration platform (step 900). The process assigns the internet protocol (IP) address and the medium access control (MAC) address to the copy for the node (step 902). The process routes the workloads from the node to the copy for the node using the network load balancer (step 904). The process terminates thereafter.

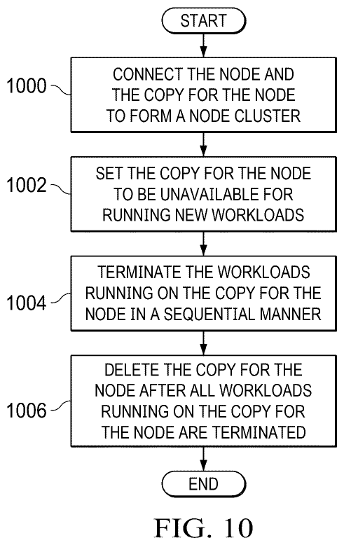

With reference now to FIG. 10, a flowchart illustrating a process for allocating the workloads from the copy for the node back to the node is shown in accordance with an illustrative embodiment. The process in this flowchart is an example of an implementation for step 508 in FIG. 5.

The process begins by connecting the node and the copy for the node to form a node cluster (step 1000). The process sets the copy for the node to be unavailable for running new workloads (step 1002). The process terminates the workloads running on the copy for the node in a sequential manner (step 1004). In step 1004, the workloads are restarted on the node according to sequence for the sequential manner after the workloads are terminated on the copy for the node. The process deletes the copy for the node after all workloads running on the copy for the node are terminated (step 1006). The process terminates thereafter.

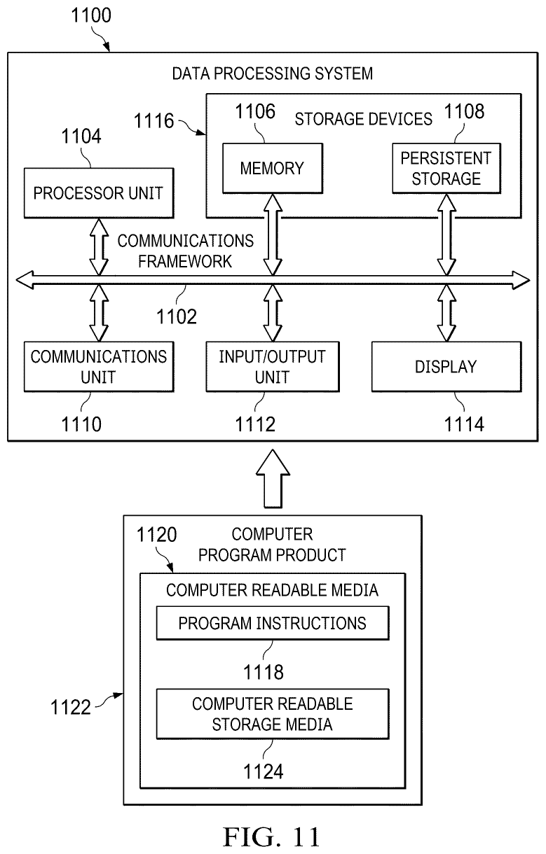

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 204 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer-readable program instructions that can be read and executed by a processor in processor unit 1104. The program instructions in the different embodiments can be embodied on different physical or computer-readable storage media, such as memory 1106 or persistent storage 1108.

Program instructions 1118 are located in a functional form on computer readable media 1120 that is selectively removable and can be loaded onto or transferred to data processing system 1100 for execution by processor unit 1104. Program instructions 1118 and computer readable media 1120 form computer program product 1122 in these illustrative examples. In the illustrative example, computer readable media 1120 is computer readable storage media 1124.

Computer readable storage media 1124 is a physical or tangible storage device used to store program instructions 1118 rather than a medium that propagates or transmits program instructions 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer readable signal media. The computer readable signal media are signals and can be, for example, a propagated data signal containing program instructions 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1120” can be singular or plural. For example, program instructions 1118 can be located in computer readable media 1120 in the form of a single storage device or system. In another example, program instructions 1118 can be located in computer readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer readable media 1120 in a server computer while another portion of program instructions 1118 can be located in computer readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for updating a node in an orchestration platform, the computer implemented method comprising:
receiving, by a processor set, a patch of a disruptive update for the node in the orchestration platform, wherein the node is a control plane node that is configured to run workloads;
generating, by the processor set, a copy for the node in the orchestration platform;
allocating, by the processor set, the workloads for the node to the copy for the node;
updating, by the processor set, the node using the patch of the disruptive update, wherein the workloads are running on the copy for the node when the node is updating; and
allocating, by the processor set, the workloads from the copy for the node back to the node upon finishing the disruptive update.

2. The computer implemented method of claim 1, further comprising:
determining, by the processor set, whether a logical partition has sufficient computing resources to store the copy for the node, wherein the node is located in the logical partition; and
in response to determining that the logical partition has sufficient computing resources to store the copy for the node, placing, by the processor set, the copy for the node into the logical partition.

3. The computer implemented method of claim 2, further comprising:
in response to determining that the logical partition does not have sufficient computing resources to store the copy for the node, identifying, by the processor set, a second logical partition for placing the copy for the node, wherein the second logical partition has lowest latency for the copy for the node to run the workloads.

4. The computer implemented method of claim 2, further comprising:
in response to determining that the logical partition does not have sufficient computing resources to store the copy for the node, reconfiguring, by the processor set, the logical partition to increase available computing resources in the logical partition; and
placing, by the processor set, the copy for the node into the logical partition.

5. The computer implemented method of claim 1, further comprising:
attaching, by the processor set, a network interface to the copy for the node, wherein the network interface comprises an internet protocol (IP) address and a medium access control (MAC) address that can be assigned to the copy for the node.

6. The computer implemented method of claim 5, further comprising:
adding, by the processor set, the internet protocol (IP) address and the medium access control (MAC) address that can be assigned to the copy for the node to a network load balancer for the orchestration platform;
assigning, by the processor set, the internet protocol (IP) address and the medium access control (MAC) address to the copy for the node; and
routing, by the processor set using the network load balancer, the workloads from the node to the copy for the node.

7. The computer implemented method of claim 1, wherein allocating, by the processor set, the workloads from the copy for the node back to the node upon finishing the disruptive update comprises:
connecting, by the processor set, the node and the copy for the node to form a two node cluster;
setting, by the processor set, the copy for the node to be unavailable for running new workloads;
terminating, by the processor set, the workloads running on the copy for the node in a sequential manner, wherein the workloads are restarted on the node according to sequence for the sequential manner after the workloads are terminated on the copy for the node; and
deleting, by the processor set, the copy for the node after all workloads running on the copy for the node are terminated.

8. A computer system comprising:
a processor set;
a set of one or more computer-readable storage media; and
program instructions, collectively stored in the set of one or more storage media, for causing the processor set to perform the following computer operations:
receive a patch of a disruptive update for a node in an orchestration platform, wherein the node is a control plane node that is configured to run workloads;
generate a copy for the node in the orchestration platform;
allocate the workloads for the node to the copy for the node;
update the node using the patch of the disruptive update, wherein the workloads are running on the copy for the node when the node is updating; and
allocate the workloads from the copy for the node back to the node upon finishing the disruptive update.

9. The computer system of claim 8, wherein the program instructions, collectively stored in the set of one or more storage media, further cause the processor set to perform the following computer operations:
determine whether a logical partition has sufficient computing resources to store the copy for the node, wherein the node is located in the logical partition; and
in response to determining that the logical partition has sufficient computing resources to store the copy for the node, placing the copy for the node into the logical partition.

10. The computer system of claim 9, wherein the program instructions, collectively stored in the set of one or more storage media, further cause the processor set to perform the following computer operations:
in response to determining that the logical partition does not have sufficient computing resources to store the copy for the node, identifying a second logical partition for placing the copy for the node, wherein the second logical partition has lowest latency for the copy for the node to run the workloads.

11. The computer system of claim 9, wherein the program instructions, collectively stored in the set of one or more storage media, further cause the processor set to perform the following computer operations:
in response to determining that the logical partition does not have sufficient computing resources to store the copy for the node, reconfigure the logical partition to increase available computing resources in the logical partition; and
store the copy for the node into the logical partition.

12. The computer system of claim 8, wherein the program instructions, collectively stored in the set of one or more storage media, further cause the processor set to perform the following computer operations:
attach a network interface to the copy for the node, wherein the network interface comprises an internet protocol (IP) address and a medium access control (MAC) address that can be assigned to the copy for the node.

13. The computer system of claim 12, wherein the program instructions, collectively stored in the set of one or more storage media, further cause the processor set to perform the following computer operations:
add the internet protocol (IP) address and the medium access control (MAC) address that can be assigned to the copy for the node to a network load balancer for the orchestration platform;
assign the internet protocol (IP) address and the medium access control (MAC) address to the copy for the node; and
route the workloads from the node to the copy for the node using the network load balancer.

14. The computer system of claim 8, wherein as part of allocating, by the processor set, the workloads from the copy for the node back to the node upon finishing the disruptive update, the program instructions, collectively stored in the set of one or more storage media, cause the processor set to perform the following computer operations:
connect the node and the copy for the node to form a two node cluster;
set the copy for the node to be unavailable for running new workloads;
terminate the workloads running on the copy for the node in a sequential manner, wherein the workloads are restarted on the node according to sequence for the sequential manner after the workloads are terminated on the copy for the node; and
delete the copy for the node after all workloads running on the copy for the node are terminated.

15. A computer program product for updating a node in an orchestration platform, the computer program product comprising:
a set of one or more computer-readable storage media;
program instructions, collectively stored in the set of one or more storage media, cause a processor set to perform the following computer operations:
receive a patch of a disruptive update for the node in the orchestration platform, wherein the node is a control plane node that is configured to run workloads;
generate a copy for the node in the orchestration platform;
allocate the workloads for the node to the copy for the node;
update the node using the patch of the disruptive update, wherein the workloads are running on the copy for the node when the node is updating; and
allocate the workloads from the copy for the node back to the node upon finishing the disruptive update.

16. The computer program product of claim 15, wherein the program instructions, collectively stored in the set of one or more storage media, further cause the processor set to perform the following computer operations:
determine whether a logical partition has sufficient computing resources to store the copy for the node, wherein the node is located in the logical partition; and
in response to determining that the logical partition has sufficient computing resources to store the copy for the node, placing the copy for the node into the logical partition.

17. The computer program product of claim 16, wherein the program instructions, collectively stored in the set of one or more storage media, further cause the processor set to perform the following computer operations:
in response to determining that the logical partition does not have sufficient computing resources to store the copy for the node, identifying a second logical partition for placing the copy for the node, wherein the second logical partition has lowest latency for the copy for the node to run the workloads.

18. The computer program product of claim 16, wherein the program instructions, collectively stored in the set of one or more storage media, further cause the processor set to perform the following computer operations:
in response to determining that the logical partition does not have sufficient computing resources to store the copy for the node, reconfigure the logical partition to increase available computing resources in the logical partition; and
store the copy for the node into the logical partition.

19. The computer program product of claim 15, wherein the program instructions, collectively stored in the set of one or more storage media, further cause the processor set to perform the following computer operations:
attach a network interface to the copy for the node, wherein the network interface comprises an internet protocol (IP) address and a medium access control (MAC) address that can be assigned to the copy for the node.

20. The computer program product of claim 15, wherein the program instructions, collectively stored in the set of one or more storage media, further cause the processor set to perform the following computer operations:
connect the node and the copy for the node to form a two node cluster;
set the copy for the node to be unavailable for running new workloads;
terminate the workloads running on the copy for the node in a sequential manner, wherein the workloads are restarted on the node according to sequence for the sequential manner after the workloads are terminated on the copy for the node; and
delete the copy for the node after all workloads running on the copy for the node are terminated.
